(19) United States
(12) Patent Application Publication
(10) Pub. No.: US 2024/0091807 A1
(43) Pub. Date: Mar. 21, 2024

(54) MASKING TOOLS AND METHODS

(71) Applicant: The Boeing Company, Arlington, VA (US)

(72) Inventor: David M. Dembeck, Puyallup, WA (US)

(73) Assignee: The Boeing Company, Arlington, VA (US)

(21) Appl. No.: 18/450,600

(22) Filed: Aug. 16, 2023

Related U.S. Application Data
(60) Provisional application No. 63/376,462, filed on Sep. 21, 2022.

(51) Int. Cl. B05C 21/00

(52) U.S. Cl. CPC B05C 21/005

(57) ABSTRACT

A masking tool includes a body portion; a masking portion supported by the body portion, the masking portion having an engagement surface sized to fit a periphery of the opening; and a retention member extending from the body portion, the retention member being positioned to engage a surface of the recess to retain at least a portion of the body portion within the recess and to maintain the engagement surface of the masking portion against the periphery of the opening.

### PRIORITY

This application claims priority from U.S. Ser. No. 63/376,462 filed on Sep. 21, 2022.

### FIELD

The present disclosure generally relates to masking tools and methods for using the masking tools and, more particularly, to masking tools for inhibiting a coating from being applied to an opening in a structure, as well as methods for using such masking tools to inhibit a coating from being applied to an opening in a structure.

### BACKGROUND

Manufactured items, such as parts, components or structures used in the manufacture of industrialized products, such as aircraft, automobiles and machinery, may be coated with various materials and substances, such as paint, to adapt the items for their intended purpose. In coating operations, the surface of the part, component or structure may be completely exposed to the coating substance. Often the part, component or structure may include features that must not be coated. The part, component or structure may have surfaces which define voids in the structure, such as an opening, hole, cavity or recess, where coating materials or substances could enter and undesirably come into contact with the internal surfaces of the opening, hole, cavity or recess.

For example, the part, component or structure may include an opening, hole, cavity or recess that receives another part, component or structure. It is undesirable to apply a coating material or substance to the internal surfaces of these types of parts, components or structures for many reasons. The opening, hole, cavity or recess must remain free from the coating material or substance and other debris or contaminants that may be present during a coating operation. This assures that the other part, component or structure received in the opening, hole, cavity or recess may function or operate as intended. For example, it may be undesirable to apply paint to the internal surfaces of an opening, hole, cavity or recess because the paint may interfere with the fitment of the other part, component or structure within the opening, hole, cavity or recess. It may also be undesirable for the coating material or substance to come into contact with the internal surfaces of the opening, hole, cavity or recess because the coating material or substance may damage the internal surface of the part, component or structure.

Various previously known approaches have been used to mask, or temporarily close openings, holes, cavities or recesses in parts, components or structures. This is an attempt to prevent coating material or substance from coming into contact with the internal surfaces of the opening, hole, cavity, recess or components that may be therein. The previously known approaches used to close openings, holes, cavities or recesses are labor intensive to install and remove and may not provide adequate protection. The previously known approaches include the manual application of masking tape or use of complex multi-piece plugs. These approaches may be less than adequate in completely sealing off a coating from the interior of a part. There may also be issues with the introduction of foreign object debris or with material compatibility.

The manual masking operation has shortcomings in many cases. When the masking tape is applied by hand from a trained technician it is labor intensive and time consuming. In such labor intensive and time-consuming masking processes, the resulting manufacturing cost may undesirably increase. When the masking tape is removed, the interface between the masking tape and the coating material or substance can crack, chip, and/or delaminate, which could result in an aesthetically unpleasing rough or otherwise disturbed edge, that is perceived as poor quality. The masking tape that is removed is typically discarded and becomes costly waste. Further, masking tape can leave adhesive residue on the article that can be undesirable. There are often numerous openings, holes, cavities or recesses in the part, component or structure that is to be coated or painted. It can be precise, tedious and repetitive work to mask the numerous openings, holes, cavities recesses in the part, component or structure that is typically done by trained technicians.

Thus, it is desirable to eliminate the manual application of the masking tape to prevent coating within the openings, holes, cavities or recesses in parts, components or structures. It is also desirable to develop a masking system that is simple to install and remove. Such a masking system must be coating or paint friendly, free of surface contaminants, not leave any residue, not scratch or damage the parts components or structures and any applied coating. It would be desirable to reuse the masking system in order to be cost-effective. The masking system must be able to accommodate varying size of openings, holes, cavities or recesses and any structural components that may be internal. The masking system must also be able to accommodate variation in structural components size and shape within the openings, holes, cavities or recesses. It is also desired to identify parts of the masking system that may fit in specific openings, holes, cavities or recesses to minimize the time that a trained technician devotes to employing the system.

### SUMMARY

Disclosed are masking tools for masking an opening in a structure, wherein the opening borders a recess in the structure.

In one example, the disclosed masking tool includes a body portion; a masking portion supported by the body portion, the masking portion having an engagement surface sized to fit a periphery of the opening; and a retention member extending from the body portion, the retention member being positioned to engage a surface of the recess to retain at least a portion of the body portion within the recess and to maintain the engagement surface of the masking portion against the periphery of the opening.

In another example, the disclosed masking tool includes a body portion to position and secure the body portion within the recess in the structure; a masking portion supported by the body portion, the masking portion having an engagement surface sized to fit a periphery of the opening; a retention member extending from the body portion, the retention member for engaging a surface of the recess to retain at least a portion of the body portion within the recess and to maintain the engagement surface of the masking portion against the periphery of the opening; and the retention member constructed to resiliently deform from an initial configuration to a compliant configuration while engaging the surface of the recess and resiliently returning towards the initial configuration after the body portion is in an attached position.

Also disclosed are methods for masking an opening in a structure, wherein the opening borders a recess located within the structure.

In one example, the disclosed method includes steps of (1) incorporating a body portion into an opening in a pliable masking portion to form a masking tool; (2) mounting the body portion of the masking tool into the opening in the structure; (3) conforming an engagement surface of the masking portion to a periphery of the opening in the structure while inserting the body portion of the masking tool into the recess in the structure; and (4) advancing the body portion of the masking tool for a deformable retention member extending from the body portion to engage a surface of the recess to retain the masking portion in a position relative to the opening in the structure.

In another example, the disclosed method includes steps of (1) mounting a masking tool into the opening in the structure; (2) advancing the masking tool into the recess for a resiliently deformable retention member extending from the masking tool to engage structure of the recess to retain the masking portion in a position relative to the opening in the structure; (3) conforming a pliable engagement surface of the masking tool to a periphery of the opening in the structure; (4) applying paint to areas of the structure where the masking tool is not mounted and inhibiting the application of paint where the masking tool is mounted; (5) removing the masking tool from the opening in the structure by applying a force to the masking tool in a direction away from the structure; and (6) reusing the masking tool by mounting the masking tool into another opening in a structure.

Other examples of the disclosed masking tools and methods for using masking tools will become apparent from the following detailed description, the accompanying drawings and the appended claims.

### BRIEF DESCRIPTION OF THE DRAWINGS

FIG. 1 is a perspective view of a masking tool installed in an opening in a structure and taken from a rearward looking position;

FIG. 2 is perspective view, similar to FIG. 1, of the masking tool prior to installation in the opening in the structure;

FIG. 3 is a cross-sectional view of the masking tool prior to installation in the opening in the structure;

FIG. 4 is a cross-sectional view of the masking tool, similar to FIG. 3, after installation into the opening in the structure;

FIG. 5 is a perspective view of the masking tool taken from a forward looking position;

FIG. 6 is an exploded perspective view of the masking tool taken from a rearward looking position;

FIG. 7 is an enlarged exploded perspective view of the masking tool taken from a forward looking position;

FIGS. 8A-8G are partial perspective views taken from the forward looking side of the masking tool illustrating various examples of retention members; and

FIG. 9 is a block diagram of the steps in a method for using the disclosed masking tool.

### DETAILED DESCRIPTION

The shortcomings of the previously known approaches are overcome in one aspect. The manual application of masking tape to openings, holes, cavities or recesses (hereinafter collectively referred to as “opening” or “recess”) in parts, components or structures (hereinafter referred to as “structure”) is eliminated. A masking system is developed that is simple to install and remove. The masking system is coating or paint friendly, free of surface contaminants, does not leave any residue, does not scratch or damage the structures and any applied coating. The masking system is able to be reused to be cost-effective. The masking system can accommodate varying size and shape of openings, holes, cavities or recesses and any internal structural components. The masking system has features that identify where the masking tool may fit in a specific opening or recess to minimize a trained technician's time in deploying the masking system.

In the one aspect, a masking tool is for masking an opening in a structure. The opening borders a recess in the structure. The masking tool comprises a body portion to position and secure the body portion within the recess in the structure. A masking portion is supported by the body portion. The masking portion has an engagement surface closely shaped and sized to tightly fit or conform to a periphery of the opening. A retention member extends from the body portion. The retention member is for engaging a surface of the recess to retain at least a portion of the body portion within the recess and to maintain the engagement surface of the masking portion against the periphery of the opening.

The retention member is constructed to resiliently deform. In other words, the retention member deforms from a non-retaining initial configuration to a compliant retaining configuration by engaging a surface or structure of the recess. The retention member may resiliently return towards the initial configuration after the retention member is in a mounted or installed position to secure the masking tool in a desired masking position. The retention member may be selected from a variety of alternative designs.

The engagement surface of the masking portion is made from a pliable material. The engagement surface of the masking portion is resiliently deformable against and conformable to the periphery of the opening when the retention member is in the retaining configuration in the recess of the structure. The masking portion may include a surface defining an opening for at least partially receiving the body portion therein. The masking tool may include opposing stop walls on the body portion to retain the masking portion.

A handle may be provided on the body portion on an opposite side of the body portion from the retention member. The handle is for manual engagement to assist in the deployment of the masking tool into the opening. The handle is also for manual engagement to remove the masking tool from the opening. The masking tool is removable from within the recess by applying a force to the handle in a direction away from the structure and enables reuse of the masking tool. The masking tool may include indicia on the body portion or the masking portion of a location on the structure of an opening and recess to be masked.

During a painting operation with the masking tool mounted or installed in the opening and/or recess, the masking portion inhibits paint application into an area where the masking is mounted or installed. The masking tool allows or permits paint application in areas where the masking tool is not mounted or installed.

A method, according to another aspect, is for masking an opening in a structure. The opening borders a recess located within the structure. The method includes identifying an opening in the structure to mask by indicia on a masking tool. The method also may include incorporating a body portion into an opening in a pliable masking portion to form the masking tool. The body portion of the masking tool is inserted into the opening in the structure. An engagement surface of the masking portion conforms to a periphery of the opening in the structure while advancing the body portion of the masking tool into the recess in the structure. The body portion of the masking tool is advanced so a resiliently deformable retention member extending from the body portion engages a surface of the recess to retain the masking portion in a position relative to the opening in the structure. The method may include selecting the resiliently deformable retention member from several alternative designs.

The method may include receiving the body portion at least partially in an opening in the masking portion. The masking portion may be positioned between stop walls on the body portion to retain the masking portion.

A sufficient force may be applied to a handle of the body portion to remove the masking tool from the recess and opening in the structure for reuse. The method may further include removing the masking portion from within the recess by applying a force to the handle in a direction away from the structure and reusing the masking tool. The method may include applying paint to areas where the masking portion is not mounted and inhibiting the application of paint where the masking portion is mounted.

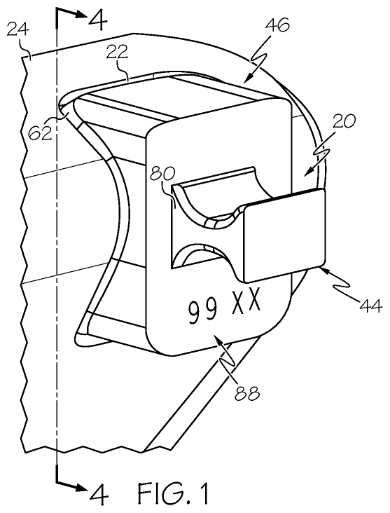

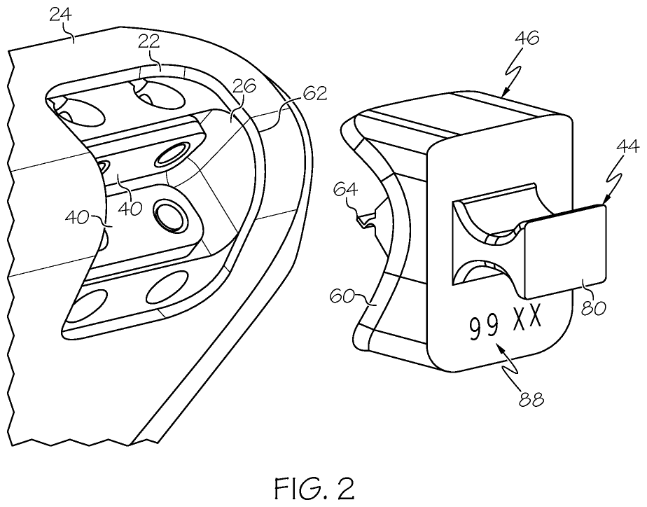

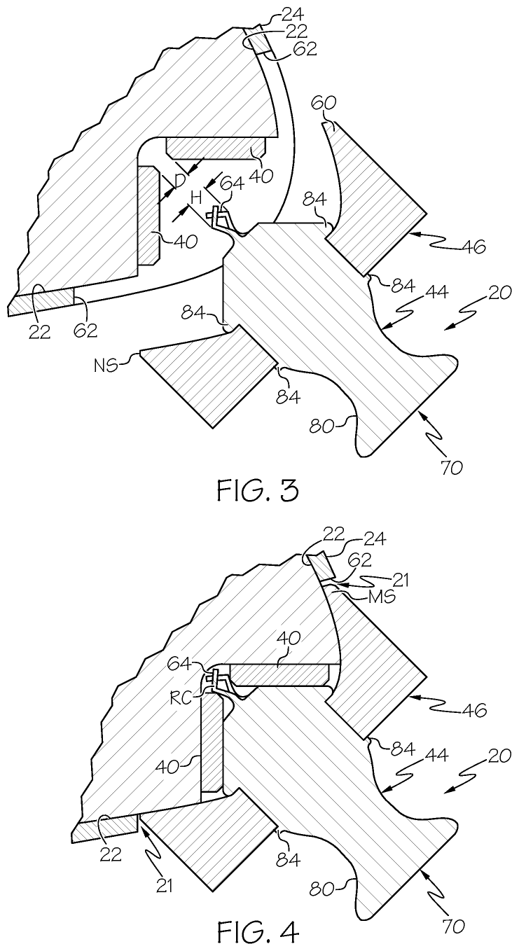

Referring now to the drawings, the newly developed masking system includes a masking tool 20 (FIGS. 1 and 2) for masking an opening 22 in a structure 24, according to one aspect. The opening 22 borders or defines a recess 26 in the structure 24. Such an opening 22 may be present in a variety of structures 24, by way of example, such as a leading edge of an aircraft wing or airfoil. There may be a variety of components or mechanisms within the recess 26, for example stop plates 40 (FIG. 2) for slats or flaps (not shown) of the aircraft. The stop plates 40 are spaced apart by a distance D (FIG. 3) which may often vary among openings 22. There are often many openings 22 and recesses 26 in the structure 24. The openings 22 and recesses 26 in the structure 24 may be of any size and shape. The openings 22 and recesses 26 in the structure 24 may be of various sizes and shapes in the same structure.

It is often quite difficult to prevent a coating such as paint, from entering the openings 22 and recesses 26 in the structure 24. Such a coating may be detrimental to the operation or function of the components or mechanisms within the recess 26. The shape and size of the masking tool 20 closely corresponds to the shape and size of the opening 22 and recess 26. The masking tool 20 is illustrated in FIG. 1 as being mounted or installed in the opening 22 to inhibit (if not prevent) coatings from entering the recess 26. The masking tool 20 is illustrated in FIG. 2 as in a non-mounted or non-installed position.

The masking tool 20 is particularly useful to completely seal off the opening 22 and recess 26 from a coating material or other substances being applied to the structure 24, for example during a painting operation. The masking tool 20 may be inserted into the opening 22 in the structure 24 in order to inhibit coating materials and other substances, such as paint, from entering the opening and coming into contact with an inner surface of the opening 22 and/or recess 26 in the structure 24. The masking tool 20 may also inhibit coating materials and other substances from being applied to or contacting any component or components that may be in the recess 26. The masking tool 20 is free of foreign object and debris. The masking tool 20 also is compatible with a variety of materials that may be used in the structure 24. The masking tool 20 does not have any adhesives that could leave residue on the structure which can be undesirable. The masking tool 20 may reduce much of the time and cost associated with manual masking of openings 22 and recesses 26 in structures 24. While the masking tool 20 is illustrated as a substantially rectangular configuration, the masking tool may be made in any size and shape suitable to be at least partially inserted into the opening 22 and/or recess 26 in the structure 24.

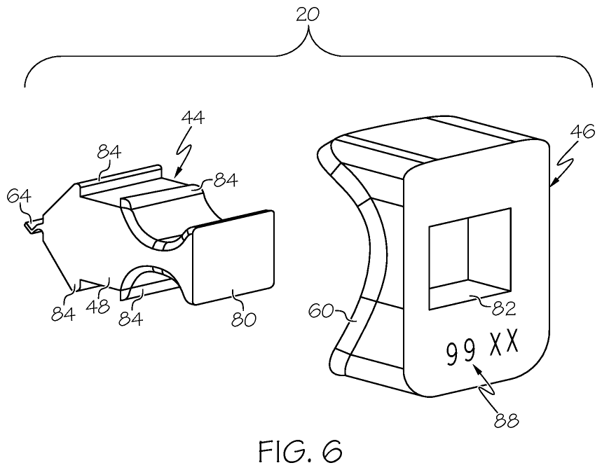

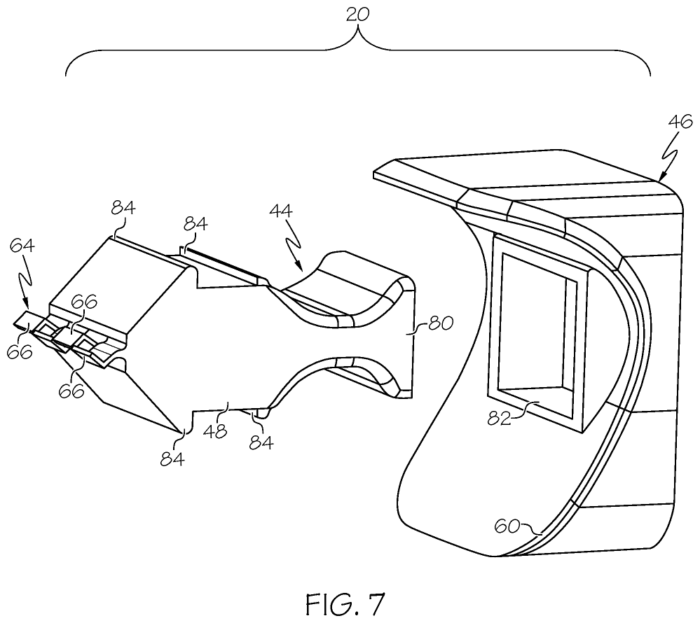

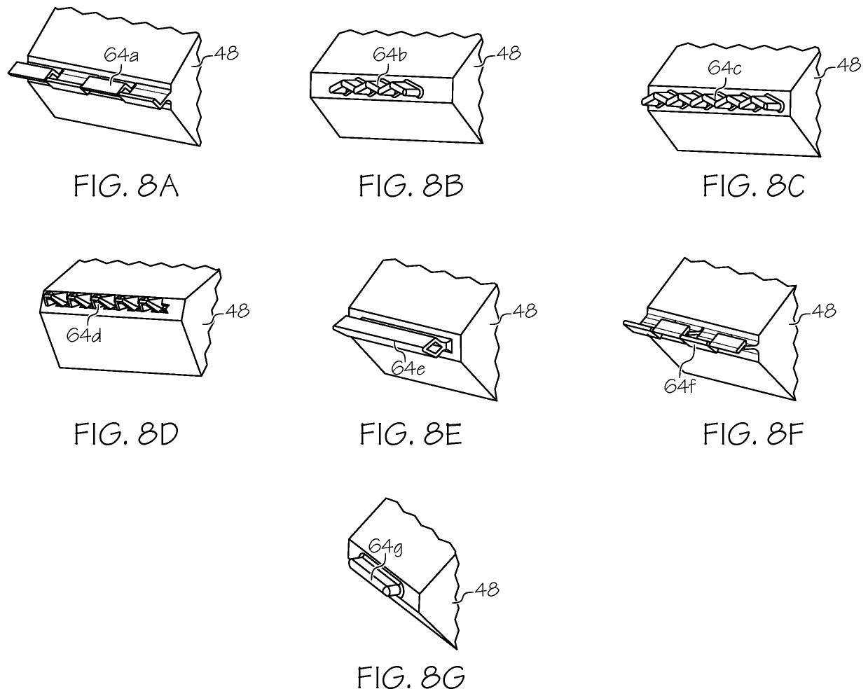

The masking tool 20 may be of a single one-piece integrally formed component. Alternatively, the masking tool 20 may be constructed of two components, as illustrated in FIGS. 1-7. The masking tool 20 includes a body portion 44 and a masking portion 46. The body portion 44 has a segment 48 (FIGS. 6 and 7) constructed to guide the body portion within the recess 26 in the structure 24. The masking portion 46 is supported by the body portion 44. The masking portion 46 has an engagement surface 60 sized to closely fit a periphery 62 of the opening 22 and recess 26.

The body portion 44 may be used with other masking portions 46 to provide manufacturing economy. For example, the masking tool 20 may be associated with a set that includes, for example, one, universal body portion 44 and a plurality of masking portions 46, each masking portion 46 of the plurality of masking portions 46 being sized and shaped to fit a specific opening 22.

The masking portion 46 may be made of a pliable material suitable to adapt or conform to the size and shape of the opening 22 upon insertion of the masking tool 20 into the opening. By way of a non-limiting example, the masking portion 46 may be made of an elastomeric material. The body portion 44 may be made from the same material as the masking portion 46 or from a plastic material that may be relatively stronger than the material of the masking portion.

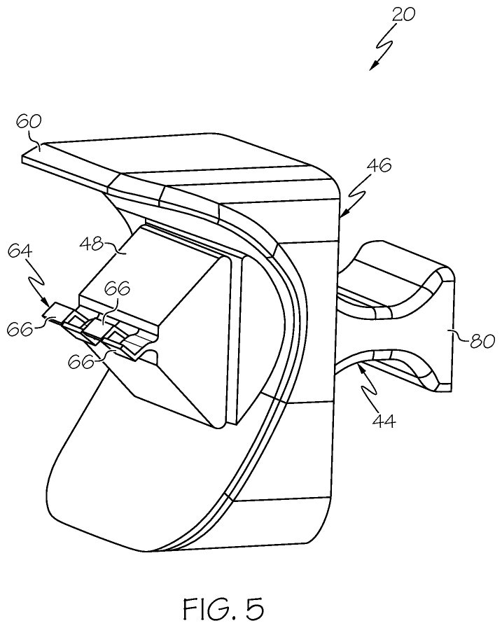

A retention member 64 extends from an end of the segment 48 of the body portion 44. The retention member 64 is for engaging a surface or components of the recess 26, such as the stop plates 40, to retain at least a portion of the body portion 44 within the recess. In one aspect, the retention member 64 is formed by an alternating series of V-shaped clips 66 (FIGS. 5 and 7). Each of the clips 66 is preferably formed integrally as one-piece with the body portion 44 of the masking tool 20. Each of the clips 66 is resiliently deflectable. The clips 66 of the retention member 64 are constructed to resiliently deflect from a non-retaining initial configuration IC, as viewed in FIG. 3, to a retaining configuration RC, as viewed in FIG. 4. The height H, as viewed in FIG. 3, of the retention member 64 is relatively larger than the distance D between the stop plates 40. When the retention member 64 is fully pushed into the stop plates 40 the clips 66 are compressed to fit in the distance D between the stop plates 40. Upon a slight further advancement, the resiliently clips 66 snap or expand towards the initial configuration IC so the clips are in the retaining configuration RC. The clips when in the retaining configuration RC, secure the masking tool 20 in a desired masking position within the structure 24.

The retention member 64 may take any shape, size and form that will be suitable for its introduction between the stop plates 40. By way of example, the retention member 64 may be selected from numerous alternative designs 64A-64G, as illustrated in FIGS. 8A-8G. The alternative designs 64A-64G of the retention member 64 may include any other configurations and sizes as may be appropriate. When the retention member 64 is fully pushed into the stop plates 40 into its retaining configuration, the retention member retains the masking tool 20 in a masking position and maintains engagement surface 60 of the masking portion 46 against the periphery 62 of the opening 22.

The engagement surface 60 of the masking portion 46 is made from a pliable material, such as an elastomer. The engagement surface 60 of the masking portion 46, thus, is resiliently deformable or conformable against the periphery 62 of the opening 22 while the retention member 64 of the body portion 44 is fully inserted into the stop plates 40 located in the recess 26 in the structure 24. The engagement surface 60 of the masking portion 46 deforms from a non-masking shape NS, as illustrated in FIG. 4, to conform against the opening 22 in a masking shape MS, as illustrated in FIG. 4.

Upon engagement of the masking tool 20 with the opening 22, there may be a gap 21 defined between the periphery 62 of the opening 22 and the masking portion 46 of the masking tool 20, as shown in FIGS. 1 and 4. This gap 21 may allow the periphery 62 of the opening 22 to be painted, while inhibiting ingress of paint further into the opening.

The masking tool 20 may further include a handle 80 on the body portion 44 at an opposite side 70 of the body portion from the segment 48 and retention member 64. The handle 80 is for manual engagement or gripping to deploy and remove the masking tool 20 from the opening 22 in the structure 24. The entire masking tool 20 is removable from within the recess 26 by applying a force F (FIG. 4) to the handle 80 of the body portion 44 in a direction away from the structure 24. This enables reuse of the masking tool 20 and thereby lowers the cost of manufacturing the structure 24.

The masking portion 46 includes a surface defining an opening 82 for at least partially receiving the body portion 44 within the masking portion to form the masking tool 20. The masking tool 20 may further include opposing stop walls 84 on the body portion 44 to retain the masking portion 46 in a position relative to the body portion. When the masking portion 46 is advanced over the body portion 44 the rightmost (as viewed in FIGS. 3, 4, 6) stop walls 84 deform inward. When the masking portion 46 is fully moved or snapped against the leftmost stop walls 84, the rightmost stop walls return to the non-deformed position. An audible signal, such as a snap, may be heard. As the body portion 44 is inserted into the recess 26 defined by the opening 22, the masking portion 46 follows the body portion as if it were integrally formed as one piece with the body portion.

The masking tool 20 may include indicia 88 on the body portion 44 or the masking portion 46. The indicia 88 identifies a location on the structure 24 of an opening 22 and recess 26 to be masked. The indicia 88 helps the trained technician in identifying the appropriate opening 22 to mask, thereby saving time and cost. In FIGS. 1 and 2, the indicia 88 is shown on the masking portion 46. There will be numerous masking tools 20 of various sizes and shapes to accommodate the many varied sizes of openings 22 in structures 24. The indicia 88 enables matching the masking tool 20 to a specific opening 22 in the structure 24.

During a painting operation with the masking tool 20 mounted or installed, the masking portion 46 and its engagement surface 60 inhibits paint application into an area where the masking tool is mounted or installed. The masking tool 20 permits paint application in areas where the masking tool is not mounted or installed.

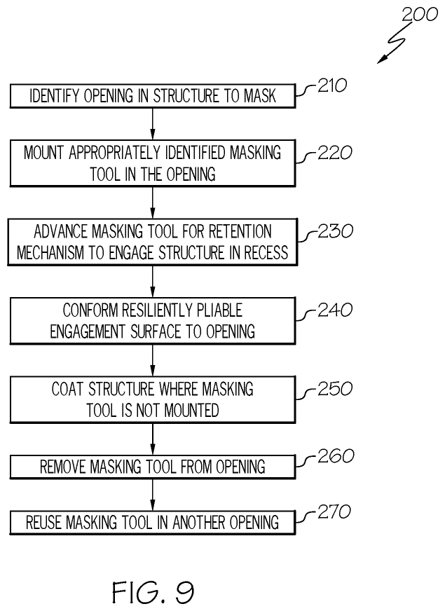

Another aspect includes a method 200 (FIG. 9) of using the masking tool 20 to mask the opening 22 in the structure 24. The method includes initial step 210 of identifying the opening 22 in the structure 24 to be masked by a particular masking tool 20. The opening 22 borders a recess 26 located within the structure 24. The masking tool 20 is chosen to match, by its indicia 88, the specific shape and size of a specific location of the opening 22 in the structure 24. This can be done by the trained technician viewing the indicia 88 on the masking tool 20 and making sure the masking tool corresponds to the appropriate opening 22. The method includes the step 220 of mounting or installing the masking tool 20 into the appropriate opening 22 in the structure 24.

At least a portion of the masking tool 20 is inserted into the recess 26. The masking tool 20 may be integrally formed as a one-piece structure. The masking tool 20 may be a two-piece structure and incorporate the body portion 44 and the masking portion 46.

In step 230, the masking tool 20 is advanced into the recess 26 and the resiliently deformable retention member 64 extending from the segment 48 of the body portion 44 engages the stop plates 40 in the opening 22 and recess 26. Individual clips 66 of the retention member 64 resiliently deflect between the stop plates 40 and then, upon further advancement, resiliently return towards their initial position to secure the masking tool 20 within the recess 26 of the structure 24. The deformable retention member 64 may be selected from numerous nonlimiting alternative clip designs 64A-64G.

As the body portion 44 of the masking tool 20 is advanced into the recess 26 defined by the opening 22 in the structure 24, in step 240, the pliable or elastically deformable engagement surface 60 of the masking portion 46 engages and conforms to the periphery 62 of the opening 22. The engagement surface 60 is matched or closely fit to the periphery 62 of the opening 22 in the structure 24. The masking tool 20 retains the masking portion 46 in a position relative to the opening in the structure 24. The masking tool 20 essentially seals off or blocks the opening 22.

A coating, such as paint, is applied to areas of the structure 24 where the masking tool 20 is not mounted or installed, in step 250. The application of the coating or paint is inhibited where the masking tool 20 is mounted or installed. After an appropriate predetermined amount of time the masking tool 20 may then be removed from the opening 22 and recess 26 in the structure 24. The masking tool 20 is removed from the opening 22 and recess 26 by applying a sufficient force F to the handle 80 of the masking tool in a direction away from the structure 24 in step 260. The masking tool 20 may then be reused or repurposed, according to step 270, to mask a different opening 22 and recess 26 in the structure 24 or another structure.

The body portion 44 may be at least partially received in the opening 82 in the masking portion 46. The masking portion 46 may be positioned between stop walls 84 on the body portion 44 to retain the masking portion relative to the body portion in a desired position during installation or removal of the masking tool 20.

Aspects may be described in the context of aircraft manufacturing and service of an aircraft or a component of the aircraft. Although an aircraft example is shown, the principles of the disclosed masking tool 20 and method 200 may be applied to other industries, such as the automotive industry or machinery manufacturing.

Although various examples of the disclosed masking tool and method for using a masking tool have been shown and described, modifications may occur to those skilled in the art upon reading the specification. The present application includes such modifications and is limited only by the scope of the claims.

1. A masking tool for masking an opening in a structure, wherein the opening borders a recess in the structure, the masking tool comprising:
a body portion;
a masking portion supported by the body portion, the masking portion comprising an engagement surface sized to fit a periphery of the opening; and
a retention member extending from the body portion, the retention member being positioned to engage a surface of the recess to retain at least a portion of the body portion within the recess and to maintain the engagement surface of the masking portion against the periphery of the opening.

2. The masking tool in claim 1 wherein the retention member is constructed to deform from a non-retaining initial configuration to a compliant retaining configuration while engaging the surface of the recess and resiliently returning towards the initial non-retaining configuration after the body portion is in an attached position.

3. The masking tool in claim 2 wherein the retention member is formed in a design selected from a plurality of alternative designs 64A-64G.

4. The masking tool in claim 1 wherein the engagement surface of the masking portion is made from a pliable material.

5. The masking tool in claim 4 wherein the engagement surface of the masking portion is resiliently deformable against the periphery of the opening from a non-masking shape to a masking shape while the body portion is inserted into the recess in the structure.

6. The masking tool in claim 1 further including a handle on the body portion on an opposite side of the body portion from the retention member, the handle for engagement to deploy and remove the masking tool.

7. The masking tool in claim 6 wherein the body portion is removable from within the recess by applying a force to the handle in a direction away from the structure and enabling reuse of the masking tool.

8. The masking tool in claim 1 wherein the masking portion comprises a surface defining an opening for at least partially receiving the body portion therein.

9. The masking tool in claim 8 further comprising opposing stop walls on the body portion to retain the masking portion.

10. The masking tool in claim 1 further comprising indicia on at least one of the body portion and the masking portion of a location on the structure of an opening and recess to be masked.

11. The masking tool in claim 1 wherein, during a painting operation with the masking tool mounted, the masking portion inhibits paint application into an area where the masking tool is mounted and permits paint application in areas where the masking tool is not mounted.

12. The masking tool in claim 1 wherein the body portion comprises a segment from which the retention member extends to position and secure the body portion within the recess in the structure.

13. A masking tool for masking an opening in a structure, wherein the opening borders a recess in the structure, the masking tool comprising:
a body portion to position and secure the body portion within the recess in the structure;
a masking portion supported by the body portion, the masking portion comprising an engagement surface sized to fit a periphery of the opening;
a retention member extending from the body portion, the retention member being positioned to engage a surface of the recess to retain at least a portion of the body portion within the recess and to maintain the engagement surface of the masking portion against the periphery of the opening; and
the retention member constructed to resiliently deform from a non-retaining initial configuration to a compliant retaining configuration while engaging the surface of the recess and resiliently returning towards the initial configuration after the body portion is in an attached position.

14. The masking tool in claim 13 wherein the retention member is formed in a design selected from a plurality of alternative designs 64A-64G.

15. The masking tool in claim 13 wherein the engagement surface of the masking portion is made from a pliable material.

16. The masking tool in claim 15 wherein the engagement surface of the masking portion resiliently deforms against a periphery of the opening from a non-masking shape to a masking shape while the body portion is inserted into the recess in the structure.

17. The masking tool in claim 13 further comprising a handle on the body portion on an opposite side of the body portion from the retention member, the handle for engagement to deploy and remove the masking tool.

18. The masking tool in claim 17 wherein the body portion is removable from within the recess by applying a force to the handle in a direction away from the structure and enabling reuse of the masking tool.

19. The masking tool in claim 13 wherein the masking portion comprises a surface defining an opening for at least partially receiving the body portion therein.

20. The masking tool in claim 13 wherein, during a painting operation with the masking tool installed in the recess, the masking portion inhibits paint application into the recess and permits paint application in areas where the masking portion is not installed.

21. A method of masking an opening in a structure, wherein the opening borders a recess located within the structure, the method comprising:
incorporating a body portion into an opening in a masking portion to form a masking tool, the masking portion being pliable;
mounting the body portion of the masking tool into the opening in the structure;
conforming an engagement surface of the masking portion to a periphery of the opening in the structure while inserting the body portion of the masking tool into the recess in the structure; and
advancing the body portion of the masking tool for a deformable retention member extending from the body portion to engage a surface of the recess to retain the masking portion in a position relative to the opening in the structure.

22-26. (canceled)

27. A method of masking an opening in a structure, wherein the opening borders a recess located within the structure, the method comprising:
mounting a masking tool into the opening in the structure;
advancing the masking tool into the recess for a resiliently deformable retention member extending from the masking tool to engage structure of the recess to retain a masking portion of the masking tool in a position relative to the opening in the structure;
conforming a pliable engagement surface of the masking tool to a periphery of the opening in the structure;
applying paint to areas of the structure where the masking tool is not mounted and inhibiting application of paint where the masking tool is mounted;
removing the masking tool from the opening in the structure by applying a force to the masking tool in a direction away from the structure; and
reusing the masking tool by mounting the masking tool into another opening in a structure.

28-30. (canceled)
